(19) United States
(12) Patent Application Publication
(10) Pub. No.: US 2017/0084266 A1
(43) Pub. Date: Mar. 23, 2017

(54) VOICE SYNTHESIS APPARATUS AND METHOD FOR SYNTHESIZING VOICE

(71) Applicant: SAMSUNG ELECTRONICS CO., LTD., Gyeonggi-do (KR)

(72) Inventors: Lukasz Jakub BRONAKOWSKI, Warszawa (PL); Andrzej RUTA, Mlodych (PL); Jakub TKACZUK, Rumia (PL); Dawid KOZINSKI, Piaseczno (PL)

(73) Assignee: SAMSUNG ELECTRONICS CO., LTD., Suwon-si (KR)

(21) Appl. No.: 15/122,869

(22) PCT Filed: Dec. 18, 2014
(86) PCT No.: PCT/KR2014/012506

§ 371 Date: Aug. 31, 2016

(30) Foreign Application Priority Data
Mar. 5, 2014 (KR) 10-2014-0025968

(51) Int. Cl. G10L 13/047; G10L 13/04; G10L 15/24; G10L 25/93

(52) U.S. Cl. CPC G10L 13/047; G10L 25/93; G10L 13/043; G10L 15/24

(57) ABSTRACT

A voice synthesis apparatus is provided. The voice synthesis apparatus includes: an electrode array configured to, in response to voiceless speeches of a user, detect an electromyogram (EMG) signal from skin of the user; a speech activity detection module configured to detect a voiceless speech period of the user; a feature extractor configured to extract a signal descriptor indicating a feature of the EMG signal for the voiceless speech period; and a voice synthesizer configured to synthesize speeches by using the extracted signal descriptor.

### TECHNICAL FIELD

The present general inventive concept generally relates to providing a voice synthesis technology, and more particularly, to providing a voice synthesis apparatus and method for detecting an electromyogram (EMG) signal from skin of a user to synthesize voices by using the detected EMG signal.

### BACKGROUND ART

A user is required to speak quietly or whisper in order to reveal secret information in a particular situation. Alternatively, the user may avoid a disturbed environment. A communication based on a bio-signal may be useful to a person who has lost a speaking ability due to disease or the like.

According to the recent researches on electromyography, electrical activities that are generated through a contraction of a vocalization muscle are analyzed to efficiently deal with the above-mentioned problem. However, existing technologies have some limits.

According to the existing technologies, the small number of electrodes are used but are manually directly attached onto skin of a user.

Also, a set of single electrodes or individual electrodes are used in an existing system. This causes many problems when acquiring a signal. This also makes electrodes difficult to be rearranged between using times and increases a whole process time.

Prior to voice synthesis, collected EMG signals are scaled up and appropriately segmented to be classified as texts. This relatively increases a vocabulary size and thus causes many calculations. In order to solve this problem, there is a need for a system that automatically selects a related signal feature to optimize a speaker and changes the related signal feature into a directly audible speech.

### DISCLOSURE OF INVENTION

### Technical Problem

Exemplary embodiments address at least the above problems and/or disadvantages and other disadvantages not described above. Also, the exemplary embodiments are not required to overcome the disadvantages described above, and an exemplary embodiment may not overcome any of the problems described above.

### Solution to Problem

The exemplary embodiments provide a voice synthesis apparatus for providing a compact electrode matrix having a preset fixed internal electrode distance providing a wide cover area to skin from which electromyogram (EMG) activities are sensed.

The exemplary embodiments also provide a voice synthesis apparatus for automatically detecting a conversation period based on an analysis of EMG activities of a face muscle without vocalized conversation information.

The exemplary embodiments also provide a voice synthesis apparatus for providing a method of automatically selecting a feature of a multichannel EMG signal collecting most distinguished information. This includes a correlation between electrode feature signals for improving distinguishment power of a system and is unrelated to actual positions of electrode arrangements.

The exemplary embodiments also provide spectrum mapping for changing selected features extracted from an input EMG signal into a parameter set that is made of a directly synthesizable and audible language.

According to an aspect of the exemplary embodiments, there is provided a voice synthesis apparatus including: n electrode array configured to, in response to voiceless speeches of a user, detect an electromyogram (EMG) signal from skin of the user; speech activity detection module configured to detect a voiceless speech period of the user; feature extractor configured to extract a signal descriptor indicating a feature of the EMG signal for the voiceless speech period; and voice synthesizer configured to synthesize speeches by using the extracted signal descriptor.

The electrode array may include an electrode array comprising a plurality of electrodes having preset intervals.

The speech activity detection module may detect the voiceless speech period of the user based on maximum and minimum values of the EMG signal detected from the skin of the user.

The feature extractor may extract the signal descriptor indicating the feature of the EMG signal in each preset frame for the voiceless speech period.

The voice synthesis apparatus may further include a calibrator configured to compensate for the EMG signal detected from the skin of the user.

The calibrator may compensate for the detected EMG signal based on a pre-stored reference EMG signal. The voice synthesizer may synthesize the speeches based on a pre-stored reference audio signal.

According to another aspect of the exemplary embodiments, there is provided a voice synthesis method including: in response to voiceless speeches of a user, detecting an EMG signal from skin of the user; detecting a voiceless speech period of the user; extracting a signal descriptor indicating a feature of the EMG signal for the voiceless speech period; and synthesizing speeches by using the extracted signal descriptor.

The EMG signal may be detected from the skin of the user by using an electrode array including an electrode array including a plurality of electrodes having preset intervals.

The voiceless speech period may be detected by using maximum and minimum values of the EMG signal detected from the skin of the user.

The signal descriptor indicating the feature of the EMG signal may be extracted in preset each frame for the voiceless speech period.

The voice synthesis method may further include: compensating for the EMG signal detected from the skin of the user.

### Advantageous Effects of Invention

The detected EMG signal may be compensated for based on a pre-stored reference EMG signal, and the speeches may be synthesized based on a pre-stored reference audio signal.

### BRIEF DESCRIPTION OF DRAWINGS

The above and/or other aspects will be more apparent by describing certain exemplary embodiments with reference to the accompanying drawings, in which:

FIG. 1 is a view illustrating a face onto which electrodes are attached to measure electromyogram (EMG);

FIG. 2 is a block diagram of a voice synthesis apparatus according to an exemplary embodiment of the present general inventive concept;

FIG. 3 is a block diagram of a voice synthesis apparatus according to another exemplary embodiment of the present general inventive concept;

FIG. 4 is a view illustrating a process of respectively extracting signal features from frames, according to an exemplary embodiment of the present general inventive concept;

FIG. 5 is a view illustrating a process of mapping single frame vectors on audible parameters, according to an exemplary embodiment of the present general inventive concept;

FIG. 6 is a block diagram illustrating a calibration process, according to an exemplary embodiment of the present general inventive concept; and

FIG. 7 is a flowchart of a voice synthesis method according to an exemplary embodiment of the present general inventive concept.

### MODE FOR THE INVENTION

Exemplary embodiments are described in greater detail with reference to the accompanying drawings.

In the following description, the same drawing reference numerals are used for the same elements even in different drawings. The matters defined in the description, such as detailed construction and elements, are provided to assist in a comprehensive understanding of the exemplary embodiments. Thus, it is apparent that the exemplary embodiments can be carried out without those specifically defined matters. Also, well-known functions or constructions are not described in detail since they would obscure the exemplary embodiments with unnecessary detail.

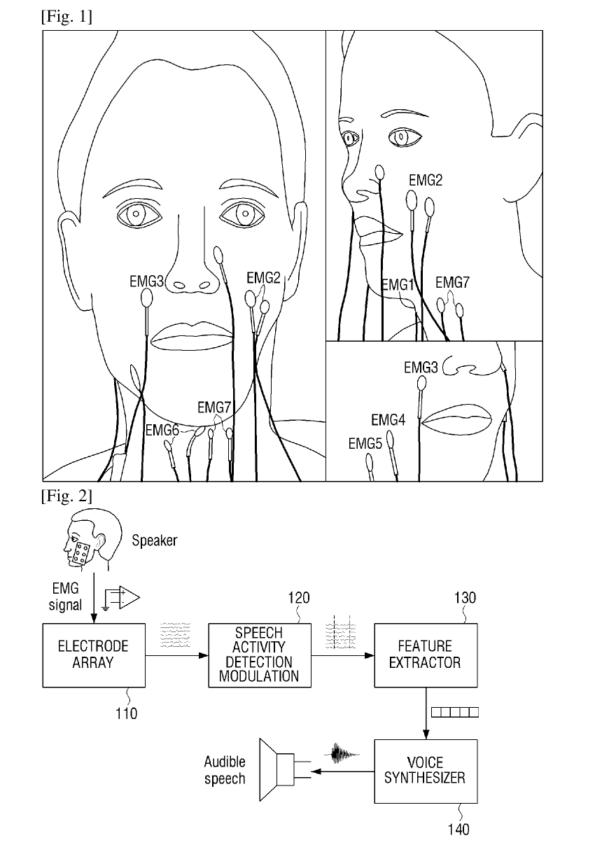

FIG. 1 is a view illustrating a face onto which electrodes are attached to measure electromyogram (EMG).

There are many technologies for processing and recognizing a voice without vocalizations based on EMG like a general bio-signal analysis.

The present general inventive concept provides a devocalization type voice recognition technology that recognizes EMG results of activities of contractions of face muscles when performing uttering to generate texts in order to perform a voice recognition. Alternatively, a text expression of a voice may be a little more processed to generate an audible voice. Currently existing apparatuses use at least one or more electrodes, may be realized as monopolar types or bipolar types, and collect EMG signals through the electrodes.

Generally used electrodes are not arranged in fixed states but are individually arranged and used on skin of the user as shown in FIG. 1. Therefore, distances between the generally used electrodes may be changed when performing uttering. Particular gel and peeking cream are used to minimize noise. Some voice recognition systems, additional formats such as audio and images and/or videos are used to provide visible information for detecting speech periods and improving accuracies of the voice recognition systems.

Various types of algorithms for analyzing differentiated bio-signals may be provided as background jobs. These algorithms include methods such as Gaussian mixture modeling, a neutral network, etc. Time domains or spectrum features are mainly independently extracted from a local area of each electrode feature channel of an input signal. Some form of descriptor is built as input to the model training module. A learned model may be mapped on a text expression most similar to a feature expression of a new bio-signal.

A detection of a speech period for a final utterance formed of one or more words is an energy-based signal expression. An assumption of a time dependence of speech that is related between word stops was first proposed by Johnson and Lamel. This methodology is a design of an audible speech signal. However, in nature, similarities of bio-signals may be applied to bio-signal expressions of a speech process. This approach and modification version is generally used for a speech endpoint detection.

Important limits of existing bio-signal-based voice processing methods are that the existing bio-signal-based voice processing methods are realized to have a bio-signal-to-text module (that converts a bio-signal into a text) and a text-to-speech module (that converts a text into a speech). These approaches may not increase scales. This is because a time for recognizing a single word increases along with a vocabulary size when performing continuous voice processing and thus exceeds a realistic continuous language processing acceptance limit.

There is no most definitive solution to session and/or user adaptation problems but there is an existing reserved approach method. Distances between electrodes are diverse in an existing electrode setup. Therefore, it is very difficult to reproduce a feature and a performance of a recognition setup between several users, and a complicated technology is required. Also, an existing system requires a session adaptation prior to being used, but this causes stress and inconvenience to a user. Finally, an existing technology depends on a process of electrodes requiring time onto a face, and this process seriously lowers usability and wholly makes an experience of a user bad.

General disadvantages of currently existing approach methods are to acquire correlations between signals that are simultaneously collected at different points of a body of a user. If the different points are spatially close to one another, the different points may be functionally related to one another or muscle tissues may overlap with one another, i.e., there may be strong correlations between acquired signals. However, the correlations may be dealt with in an EMG-based voice recognition only to some extents. Spaces for development are left in terms of voice recognition and/or synthesis accuracy.

According to an existing approach method, an acoustic and/or speech signal is recorded parallel with an EMG signal. For example, signals synchronize with one another. In this case, an audio signal is generally used for detections, and an EMG signal is segmented to distinguish speech periods. This process is required in a training process when a model extracted from a classification and/or regression analysis is established based on an extracted interest period. An audible speech is required, and thus this approach may not be applied to people who have voice disorders like people who have had laryngectomy.

FIG. 2 is a block diagram of a voice synthesis apparatus 100-1 according to an exemplary embodiment of the present general inventive concept.

Referring to FIG. 2, the voice synthesis apparatus 100-1 includes an electrode array 110, a speech activity detection module 120, a feature extractor 130, and a voice synthesizer 140.

If there is a devocalization of a user, the electrode array 110 is an element that detects an electromyogram (EMG) signal from skin of the user. In detail, an electrode array including one or more electrodes is used to collect EMG signals from the skin of the user. The electrodes are regularly arrayed to be form an array and be fixed. For example, distances between the electrodes may be uniform or may be nearly uniform. Here, the array refers to a 2-dimensional (2D) array but may be a 1-dimensional array.

The speech activity detection module 120 is an element that detects a voiceless utterance period of the user. The speech activity detection module 120 performs a multichannel analysis of an EMG signal that is collected to detect a period for which a person is voiceless or utters an audible speech.

The feature extractor 130 is an element that extracts a signal descriptor indicating a feature of the EMG signal that is collected for the voiceless utterance period. The feature extractor 130 calculates most useful feature from pieces of the EMG signal that is classified for an utterance period. The feature includes one or more features, each of which indicates an independent channel of an input signal or an arbitrary combination of channels.

The voice synthesizer 140 synthesizes voices by using the extracted signal descriptor.

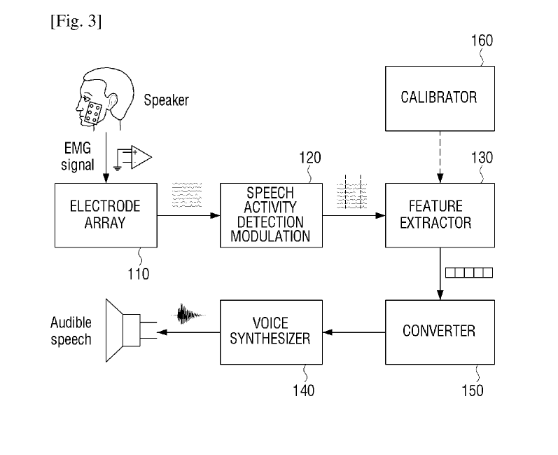

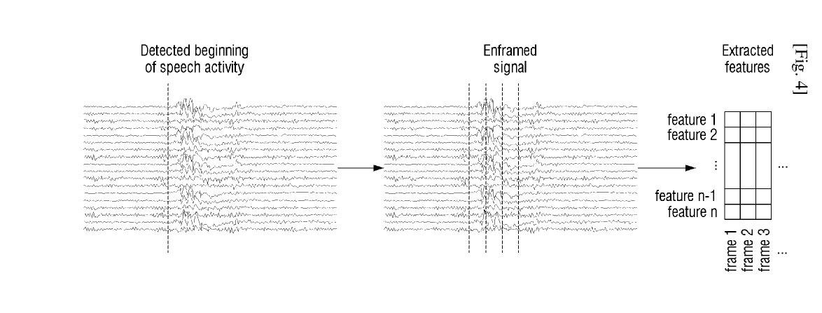

FIG. 3 illustrates an expanded exemplary embodiment. In other words, FIG. 3 is a block diagram of a voice synthesis apparatus 100-2, according to another exemplary embodiment of the present general inventive concept.

Referring to FIG. 3, the voice synthesis apparatus 100-2 includes an electrode array 110, a speech activity detection module 120, a feature extractor 130, a voice synthesizer 140, a converter 150, and a calibrator 160.

The converter 150 maps an EMG signal, which may be indicated by a feature set, on a particular parameter set characterizing an audible speech. The mapping is performed based on a preset statistical model.

The voice synthesizer 140 transmits a parameter having an acquired spectrum outside a system or converts the parameter into an audible output.

The calibrator 160 is used to automatically select the follow two kinds. In other words, the calibrator 160 automatically selects electrodes from an electrode array and electrode feature elements of signals acquiring the most useful part of an EMG signal given in current positions of arrays of the electrodes on the skin of the user. The calibrator 160 also automatically determines a statistical model parameter required at a system runtime by the converter 150.

A system operation is performed in two modes, i.e., online and offline modes. All processing operations of the online mode are performed as in a signal flow of the block diagram of FIG. 3. The online mode is designed to convert standard, continuous, and non-audible EMG signals into audible speeches in real time. The offline mode is designed for statistical model training based on an utterance set that is immediately recorded and audible by using the calibrator 160. A statistical module used in the converter 150 for a system that maps voiceless-to-audible speeches in real time may be used as a result of a calibration in advance.

Also, among all available descriptors, a lower set that is sufficiently small may be determined for a current session. A session refers to a session in which an electrode array is attached and maintained in a fixed position of the skin of the user.

When the user makes an utterance, an ionic current that slightly contracts vocalization muscles is generated and sensed by surface electrodes positioned in the electrode array to be converted into an electrical current. A ground electrode provides a common reference current to a differential input of an amplifier. In the latter case, signals are extracted from two detectors to amplify a differential voltage between two input terminals. A resultant analog signal is converted into a digital representation. An electrode, an amplifier, and analog-to-digital converter (ADC) include signal acquiring modules that are similar to methods used in existing solutions. An output multichannel digital signal is transmitted to a speech activity detection module 120.

In the speech activity detection module 120, an input signal is analyzed to determine a limit of a session in which the user has a conversation. The analysis is performed based on the following three parameters.

The first parameter is energy of a signal. The energy may be equal to a statistical value that is maximally, averagely, or independently calculated from a plurality of individual channels and then summed. The energy may also be replaced with another similar natural statistics.

The second parameter is a gradient of the parameter (i.e., a local time interval having at least one signal frame). The gradient of the parameter may be calculated for respective individual channels.

The third parameter is a time of the parameter value that may be kept higher or lower than a threshold value.

Before a threshold value of an interest statistic, the interest statistic becomes an object of low-pass filtering smoothing a signal and reduces sensitivity of the speech activity detection module 120 to vibrations and noise. A concept of the threshold value is to detect a time when energy of an input signal is sufficiently increased to estimate that the user would start speeches. Similarly, the concept of the threshold value is to detect a time when (the energy is high and then) the energy is very low for normal speeches. A duration that is limited by a threshold and continuous intersection points of the signal determines a limit of a language activity from a lowest point and a highest point. Duration thresholding is introduced to accidentally filter a short peak point from a signal. In the other cases, the duration thresholding may be detected as a speech period. The threshold values may be minutely adjusted for a particular application scenario.

FIG. 4 is a view illustrating signal features that are respectively extracted from frames, according to an exemplary embodiment of the present general inventive concept.

If beginning of a likely speech period is detected from an input signal, the feature extractor 130 calculates a signal descriptor. This is performed with a frame base as shown in FIG. 4. In other words, the signal is divided into a constant length and time windows (frames) that partially overlap one another. At this point, various descriptors may be detected. This includes energy simple time-domain statistics such as averaging, dispersing, zero crossing, spectrum type features, Mel-cepstral coefficients, linear estimation coding coefficients, etc. Recent researches imply that EMG signals recorded from different vocalization muscles are connected to one another. These correlations functionally characterize dependences between muscles and may be important for prediction purposes. Therefore, except for features describing individual channels of an input signal, several channels that are connected to one another may be calculated (e.g., internal channel correlations of different time delays). At least one vector of the above-described features is output per frame as shown in FIG. 4.

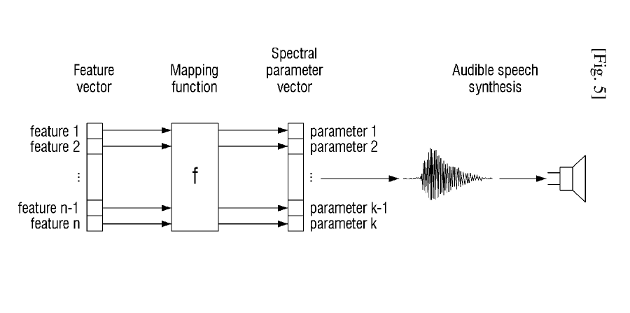

FIG. 5 is a view illustrating a process of mapping single frame vectors on audible parameters, according to an exemplary embodiment of the present general inventive concept.

The converter 150 may map single frame feature vectors on spectral parameter vectors characterizing audible speeches. The spectral parameter vectors are used for voice synthesis.

Vectors of extracted features become objects of dimensionality reductions. For example, the dimensionality reductions may be achieved through essential element analyses. In this case, it is estimated that an appropriate conversion matrix may be used at this point. A low-dimensional vector is used as an input of a prediction function that maps the low-dimensional vector on one or more spectrum parameter vectors of an audible language characterizing signal levels in different frequency bands and is statistically learned. The prediction function has continuous input and output spaces. Finally, a parameter vocoder is used to generate the audible language. As a result, waveforms are amplified and head to a requested output apparatus.

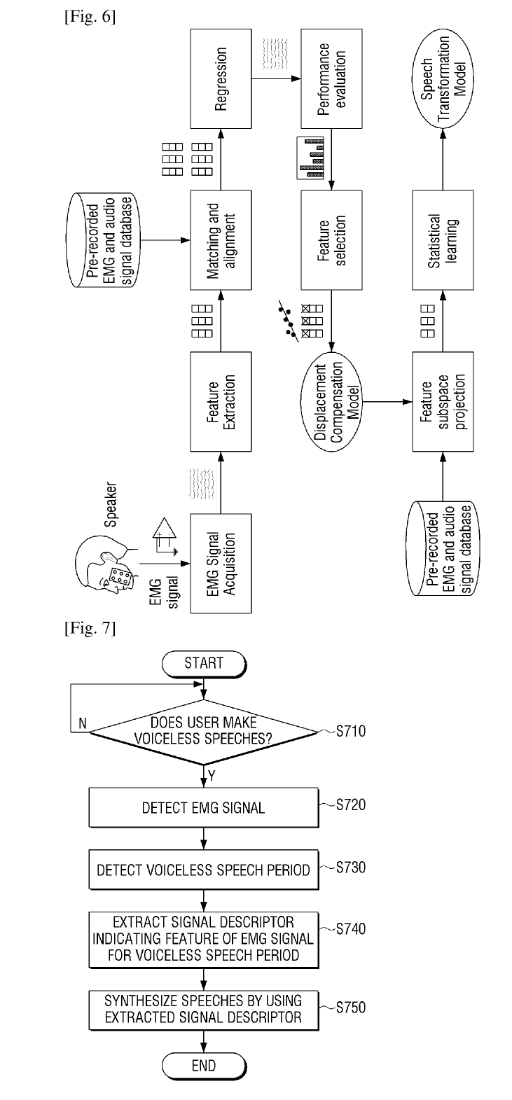

FIG. 6 is a block diagram illustrating a calibration process, according to an exemplary embodiment of the present general inventive concept.

The calibrator 160 is an essential element of a system through which a user may teach the system to synthesize a voice of the user or a voice of another person with a bio-signal detected from a body of the user.

In a past approach method to voiceless language processing, a recognition component is based on classification of statistical model learning through time requiring processing from a large amount of training data. Also, it is difficult to statistically resolve problems of the user and period dependence. One exception is wearable EMG that has a calibration function. The strategy is an extension of an original concept. A suggested system tries to learn a function that maps bio-signal features on spectrum parameters of an audible language based on training data provided by the user. (This is referred to as a speech transformation module.) An automatic on-line geometrical displacement compensation and a signal feature selection algorithm are included in a calibration process to achieve the highest clarity of a language that is synthesized to remove necessity of determining and readjusting a current electrode array position. (This is referred to as a geometrical displacement compensation model.) An outline of how a calibration model operates is illustrated in FIG. 6.

The calibration process requires a database (DB) of a reference EMG signal feature that may be used for training the speech transformation model. In order to collect the DB, the user receives a question on one-off recording occurring in an optimum environment condition where background noise does not occur at the most comfortable time and when an electrode array is accurately positioned on the skin and the user sufficiently relieves tension. Repetitions of preset speeches that may cover all characteristic vocalization muscle activation patterns are mentioned a plurality of times. Orders of speeches may be fixed in a reference order, and the above order may be wholly designed based on a professional advice of a speech therapist such as a mycologist or a machine learning background engineer

An audio signal that is synthesized with EMG recording is also necessary to establish a model so as to synthesize audible speeches in an on-line operation mode of the system. The audio signal may be simultaneously recorded along with a reference EMG signal or may be acquired from other people if users do not use speeches. In the latter case, a particular attribute of voice or prosody of a person may be reflected on synthesized speeches that are generated from an output of the system. Audio samples corresponding to EMG match one another in a simple case because orders of speeches are fixed in a reference sequence. n+1 channel signals are synthesized, wherein n denotes the number of electrodes in an array. A signal is enframed to extract an over-complete set of features for the feature extraction module 130 as described above. Here, an overcomplete means that a set includes various signal features except an expectation of particular features having important discriminable differences.

Actual calibration is performed by allowing a user to immediately pronounce short sequences of preset speeches. Since orders of speeches are fixed, the sequence may match the most similar reference signals stored in a DB and may be adjusted according to the reference signals. Finally, a recorded signal and reference signal feature vectors for feature extraction may be processed as inputs (independence parameters) and targets (subordinate parameters) of a plurality of regression analysis jobs. A regression analysis is to find optimum mapping between actual voiceless speech features and reference voiceless speech features. Before being converted into audible speech parameters, this mapping, i.e., a displacement compensation model, is applied to EMG feature vectors that are acquired when using an on-line system. If the displacement compensation model is set, a prediction error may be evaluated. An actual signal and a reference signal may be pronounced by the same user and thus may be highly similar to each other in principle. A major difference is caused by relative movement and rotation of an electrode array on a surface of the skin, which are well-known problems of period dependence. Geometrical properties of most of the above-described changes may be modeled as a relatively simple function class such as a linear or 2-dimensional (2D) function. However, a selection of a realization of a particular regression analysis is autonomically made.

A limited total amount of generated immediate input data and a regression analysis are very fast, and thus an automatic feature selection is additionally integrated into the calibration process. This is performed by investigating the number of available subsets of features in disregard of a maintained feature vector dimension. Accuracy of a displacement compensation model is reevaluated with respect to each of the subsets. A feature set that produces high accuracy is stored. The feature set operates on an individual feature level instead of the individual channel level. Therefore, according to the algorithm, a plurality of channels are analyzed and may respectively converge into setting that is expressed by different subsets of signal features.

As a result, a speech conversation model is set with a training signal DB depending on a pre-recorded user and an immediately learned displacement compensation model. The speech conversion model is set in a feature space that is covered with signal features of which relations are detected in an automatic feature selection process. A selection of a particular statistic framework for learning a function of transforming voiceless speeches into audible speeches may be arbitrary. For example, a Gaussian mixture model based on a speech transformation technique may be used. Similarly, a well-known algorithm may be used to select the above-mentioned feature. For example, there is a greedy sequential floating search or a forward or backward technique, AdaBoost technique, or the like.

The whole calibration process is intended not to require k second or more so as to increase a desire of the user to use the system (audible parameter k). The calibration process may be repeated whenever an electrode array is re-attached onto skin or is consciously and/or accidentally replaced. Alternatively, the calibration process may be repeated when being requested. For example, if qualities of synthesized audible speeches seriously get worse, feedbacks may be performed. A suggested solution is to resolve problems of period and user dependence through a natural method.

A system according to an exemplary embodiment may include an element that plugs in outputs of standard audio input apparatuses such as a portable music player, etc. An available application is not limited to a control apparatus and an application of EMG driving and may include a cell phone that is useful in all situations revealing sensitive information to the public or disturbing environments. Regardless of an actual application, the system may be used by healthy people and people with speech impediments (dysarthria or laryngectomy).

FIG. 7 is a flowchart of a voice synthesis method according to an exemplary embodiment of the present general inventive concept.

Referring to FIG. 7, in operation S710, a determination is made as to whether a user makes voiceless speeches. In operation S720, an EMG signal is detected from skin of the user. In operation S730, a voiceless speech period of the user is detected. In operation S740, a signal descriptor that indicates a feature of the EMG signal for the voiceless speech period is extracted. In operation S750, speeches are synthesized by using the extracted signal descriptor.

Here, in operation S720, the EMG signal may be detected by using an electrode array including a plurality of electrodes having preset intervals.

In operation S730, the voiceless speech period of the user may be detected based on maximum and minimum values of the EMG signal detected from the skin of the user.

In operation S740, the signal descriptor that indicates the feature of the EMG signal in preset frame units for the voiceless speech period may be extracted.

The voice synthesis method may further include: compensating for the EMG signal detected from the skin of the user.

In operation of compensating for the EMG signal, the detected EMG signal may be compensated for based on a pre-stored reference EMG signal. In operation S750, the speeches may be synthesized based on a pre-stored reference audio signal.

According to various exemplary embodiments of the present general inventive concept as described above, the present general inventive concept has the following characteristics.

An EMG sensor may be further easily and quickly attached onto skin. This is because a user selects a wearable electrode array or the electrode array is wholly temporarily attached onto the skin. On the contrary, most of other systems depend on additional accessories, such as masks or the like, that are inconvenient to users or require careful attachments of electrodes onto skin. This frequently requires time and skills to be completed.

A calibration algorithm that is executed based on an immediately provided voiceless speech sequence and an electrode matrix having a fixed inter-electrode distance are used to resolve user and period dependences. This enables the above-described algorithm to sufficiently efficiently operate.

Any precedent knowledge may not be assume in an electrode position on skin, and signal features transmit the most distinguishing information. An over-complete feature set is generated from all EMG channels. Therefore, in a calibration process, the most useful features (indirectly channels) are automatically found. In addition, the signal expression includes a feature of acquiring dependences between channels.

Audio expressions of speeches may not be required or may be pre-recorded (both in online and offline operation modes) through a whole processing path. This may be an invention appropriate for people having several speech impediments.

A provided electrode array may be fixed on a flexible surface to be easily set on a limited surface in order to be easily combined with various types of portable apparatuses such as facial shapes, cell phones, etc.

An object of a provided solution is to deal with a problem of audible voice reconstructing with only electrical activities of vocalization muscles of a user, wherein input speeches may be arbitrarily devocalized. Differently from an existing job, continuous parameters of audible speeches are directly estimated from an input digitalized biosignal and thus are different from a typical speech recognition system. Therefore, a general operation of detecting and classifying speech fragments as sentences is completely omitted. An idea of the present general inventive concept is the newest solution at three points.

An electrode array having at least two electrodes is used to acquire signals. The electrode array is temporarily attached onto skin for a speech period. The electrode array is connected to a voiceless microphone system through a bus, cable, or radio. Electrodes may be set to be monopolar or bipolar. If the electrode array is positioned on an elastic surface, distances between the electrodes may be fixed or may be slightly changed. The electrode array has a flat and compact size (e.g., does not exceed 10×10 cm.) and is easily combined with many portable devices. For example, the electrode array may be installed on a back cover of a smartphone.

A set of single electrodes or individual electrodes is used in an existing system. This causes many problems of acquiring signals. This causes difficulty re-arraying electrodes between use periods and increases a whole process time. It is inappropriate to embed separated electrodes in an apparatus. Also, if conductivity of the electrodes is to be improved enough to compensate for an appropriate signal registration, the conductivity of the electrodes may be easily improved through one electrode array.

Two new contributions to signaling are made. One does not assume that any particular expression is specially useful to accurately map voiceless speeches and audible speeches. Therefore, a pool of many features is generated, and the most useful feature is automatically selected in a calibration process. Statistics that describes correlations between a plurality of channels of an EMG signal may be included in the pool of features along with other features.

According to various exemplary embodiments of the present general inventive concept as described above, a voice synthesis apparatus is provided to provide a compact electrode matrix having a preset fixed internal electrode distance providing a wide cover area onto skin from which myoelectric activities are sensed.

Also, the voice synthesis apparatus may automatically detect a speech period based on an analysis of myoelectric activities of face muscles without vocalized conversation information.

In addition, the voice synthesis apparatus may provide a method of automatically selecting a feature of a multichannel EMG signal collecting the most distinguishing information.

The foregoing exemplary embodiments and advantages are merely exemplary and are not to be construed as limiting. The present teaching can be readily applied to other types of apparatuses. Also, the description of the exemplary embodiments is intended to be illustrative, and not to limit the scope of the claims, and many alternatives, modifications, and variations will be apparent to those skilled in the art.

1. A voice synthesis apparatus comprising:
an electrode array configured to, in response to voiceless speeches of a user, detect an electromyogram (EMG) signal from skin of the user;
a speech activity detection module configured to detect a voiceless speech period of the user;
a feature extractor configured to extract a signal descriptor indicating a feature of the EMG signal for the voiceless speech period; and
a voice synthesizer configured to synthesize speeches by using the extracted signal descriptor.

2. The voice synthesis apparatus of claim 1, wherein the electrode array comprises an electrode array comprising a plurality of electrodes having preset intervals.

3. The voice synthesis apparatus of claim 1, wherein the speech activity detection module detects the voiceless speech period of the user based on maximum and minimum values of the EMG signal detected from the skin of the user.

4. The voice synthesis apparatus of claim 1, wherein the feature extractor extracts the signal descriptor indicating the feature of the EMG signal in each preset frame for the voiceless speech period.

5. The voice synthesis apparatus of claim 1, further comprising:
a calibrator configured to compensate for the EMG signal detected from the skin of the user.

6. The voice synthesis apparatus of claim 5, wherein the calibrator compensates for the detected EMG signal based on a pre-stored reference EMG signal, and the voice synthesizer synthesizes the speeches based on a pre-stored reference audio signal.

7. A voice synthesis method comprising:
in response to voiceless speeches of a user, detecting an EMG signal from skin of the user;
detecting a voiceless speech period of the user;
extracting a signal descriptor indicating a feature of the EMG signal for the voiceless speech period; and
synthesizing speeches by using the extracted signal descriptor.

8. The voice synthesis method of claim 7, wherein the EMG signal is detected from the skin of the user by using an electrode array comprising an electrode array comprising a plurality of electrodes having preset intervals.

9. The voice synthesis method of claim 7, wherein the voiceless speech period is detected by using maximum and minimum values of the EMG signal detected from the skin of the user.

10. The voice synthesis method of claim 7, wherein the signal descriptor indicating the feature of the EMG signal is extracted in preset each frame for the voiceless speech period.

11. The voice synthesis method of claim 7, further comprising:
compensating for the EMG signal detected from the skin of the user.

12. The voice synthesis method of claim 11, wherein the detected EMG signal is compensated for based on a pre-stored reference EMG signal, and the speeches are synthesized based on a pre-stored reference audio signal.
